(19) United States
(12) Patent Application Publication
(10) Pub. No.: US 2020/0225882 A1
(43) Pub. Date: Jul. 16, 2020

(54) SYSTEM AND METHOD FOR COMPACTION-LESS KEY-VALUE STORE FOR IMPROVING STORAGE CAPACITY, WRITE AMPLIFICATION, AND I/O PERFORMANCE

(71) Applicant: Alibaba Group Holding Limited, George Town (KY)

(72) Inventor: Shu Li, Bothell, WA (US)

(73) Assignee: Alibaba Group Holding Limited, George Town (KY)

(21) Appl. No.: 16/249,504

(22) Filed: Jan. 16, 2019

(51) Int. Cl. G06F 3/06; G06F 12/02; G06F 12/10

(52) U.S. Cl. CPC G06F 3/0661; G06F 3/0608; G06F 3/0679; G06F 2212/2022; G06F 12/10; G06F 2212/1044; G06F 12/0253

(57) ABSTRACT

One embodiment facilitates data placement in a storage device. During operation, the system generates a table with entries which map keys to physical addresses. The system determines a first key corresponding to first data to be stored. In response to determining that an entry corresponding to the first key does not indicate a valid value, the system writes, to the entry, a physical address and length information corresponding to the first data. In response to determining that the entry corresponding to the first key does indicate a valid value, the system updates, in the entry, the physical address and length information corresponding to the first data. The system writes the first data to the storage device at the physical address based on the length information.

### BACKGROUND

### Field

This disclosure is generally related to the field of data storage. More specifically, this disclosure is related to a system and method for a compaction-less key-value store for improving storage capacity, write amplification, and I/O performance.

### Related Art

The proliferation of the Internet and e-commerce continues to create a vast amount of digital content. Various storage systems have been created to access and store such digital content. A storage system or server can include multiple drives, such as hard disk drives (HDDs) and solid state drives (SSDs). The use of key-value stores is increasingly popular in fields such as databases, multi-media applications, etc. A key-value store is a data storage paradigm for storing, retrieving, and managing associative arrays, e.g., a data structure such as a dictionary or a hash table.

One type of data structure used in a key-value store is a log-structured merge (LSM) tree, which can improve the efficiency of a key-value store by providing indexed access to files with a high insert volume. When using a LSM tree for a key-value store, out-of-date (or invalid) data can be recycled in a garbage collection process to free up more available space.

However, using the LSM tree for the key-value store can result in some inefficiencies. Data is stored in SST files in memory and written to persistent storage. The SST files are periodically read out and compacted (e.g., by merging and updating the SST files), and subsequently written back to persistent storage, which results in a write amplification. In addition, during garbage collection, the SSD reads out and merges valid pages into new blocks, which is similar to the compaction process involved with the key-value store. Thus, the existing compaction process associated with the conventional key-value store can result in both a write amplification and a performance degradation. The write amplification can result from the copying and writing performed during both the compaction process and the garbage collection process, and can further result in the wear-out of the NAND flash. The performance degradation can result from the consumption of the resources (e.g., I/O, bandwidth, and processor) by the background operations instead of providing resources to handle access by the host.

Thus, conventional systems which a key-value store with compaction (e.g., the LSM tree) may result in an increased write amplification and a degradation in performance. This can decrease the efficiency of the HDD as well as the overall efficiency and performance of the storage system, and can also result in a decreased level of QoS assurance.

### SUMMARY

One embodiment facilitates data placement in a storage device. During operation, the system generates a table with entries which map keys to physical addresses. The system determines a first key corresponding to first data to be stored. In response to determining that an entry corresponding to the first key does not indicate a valid value, the system writes, to the entry, a physical address and length information corresponding to the first data. In response to determining that the entry corresponding to the first key does indicate a valid value, the system updates, in the entry, the physical address and length information corresponding to the first data. The system writes the first data to the storage device at the physical address based on the length information.

In some embodiments, the system divides the table into a plurality of sub-tables based on a range of values for the keys. The system writes the sub-tables to a non-volatile memory of a plurality of storage devices.

In some embodiments, in response to detecting a garbage collection process, the system determines, by a flash translation layer module associated with the storage device, a new physical address to which to move valid data. The system updates, in a second entry corresponding to the valid data, the physical address and length information corresponding to the valid data.

In some embodiments, prior to generating the table, the system generates a first data structure with entries mapping the keys to logical addresses, and generates, by the flash translation layer associated with the storage device, a second data structure with entries mapping the logical addresses to the corresponding physical addresses.

In some embodiments, the length information corresponding to the first data indicates a starting position and an ending position for the first data.

In some embodiments, the starting position and the ending position indicate one or more of: a physical page address; an offset; and a length or size of the first data.

In some embodiments, the physical address is one or more of: a physical block address; and a physical page address.

### BRIEF DESCRIPTION OF THE FIGURES

FIG. 1A illustrates an exemplary environment for facilitating a key-value store with compaction, in accordance with the prior art.

FIG. 1B illustrates an exemplary mechanism for facilitating a key-value store with compaction, in accordance with the prior art.

FIG. 2 illustrates an exemplary environment for facilitating a compaction-less key-value store, including a table mapping keys to physical addresses, in accordance with an embodiment of the present application.

FIG. 3 illustrates an exemplary environment illustrating an improved utilization of storage capacity by comparing a key-value store with compaction (in accordance with the prior art) with a key-value store without compaction (in accordance with an embodiment of the present application).

FIG. 4A illustrates an exemplary environment for facilitating data placement in a storage device, including communication between host memory and a plurality of sub-tables in a plurality of storage devices, in accordance with an embodiment of the present application.

FIG. 4B illustrates an exemplary environment for facilitating data placement in a storage device, corresponding to the environment of FIG. 4A, in accordance with an embodiment of the present application.

FIG. 5 illustrates a mapping between keys and physical locations by a flash translation layer module associated with a storage device, including two steps, in accordance with an embodiment of the present application.

FIG. 6A illustrates an exemplary placement of a data value in a physical page, in accordance with an embodiment of the present application.

FIG. 6B illustrates an exemplary placement of a data value across multiple physical pages, in accordance with an embodiment of the present application.

FIG. 7A presents a flowchart illustrating a method for facilitating data placement in a storage device, in accordance with an embodiment of the present application.

FIG. 7B presents a flowchart illustrating a method for facilitating data placement in a storage device, in accordance with an embodiment of the present application.

FIG. 8 illustrates an exemplary computer system that facilitates data placement in a storage device, in accordance with an embodiment of the present application.

FIG. 9 illustrates an exemplary apparatus that facilitates data placement in a storage device, in accordance with an embodiment of the present application.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the embodiments described herein are not limited to the embodiments shown, but are to be accorded the widest scope consistent with the principles and features disclosed herein.

### Overview

The embodiments described herein solve the problem of improving the efficiency, performance, and capacity of a storage system by using a compaction-less key-value store, based on a mapping table between keys and physical addresses.

As described above, the use of key-value stores is increasingly popular in field such as databases, multi-media applications, etc. One type of data structure used in a key-value store is a log-structured merge (LSM) tree, which can improve the efficiency of a key-value store by providing indexed access to files with a high insert volume. When using a LSM tree for a key-value store, out-of-date (or invalid) data can be recycled in a garbage collection process to free up more available space.

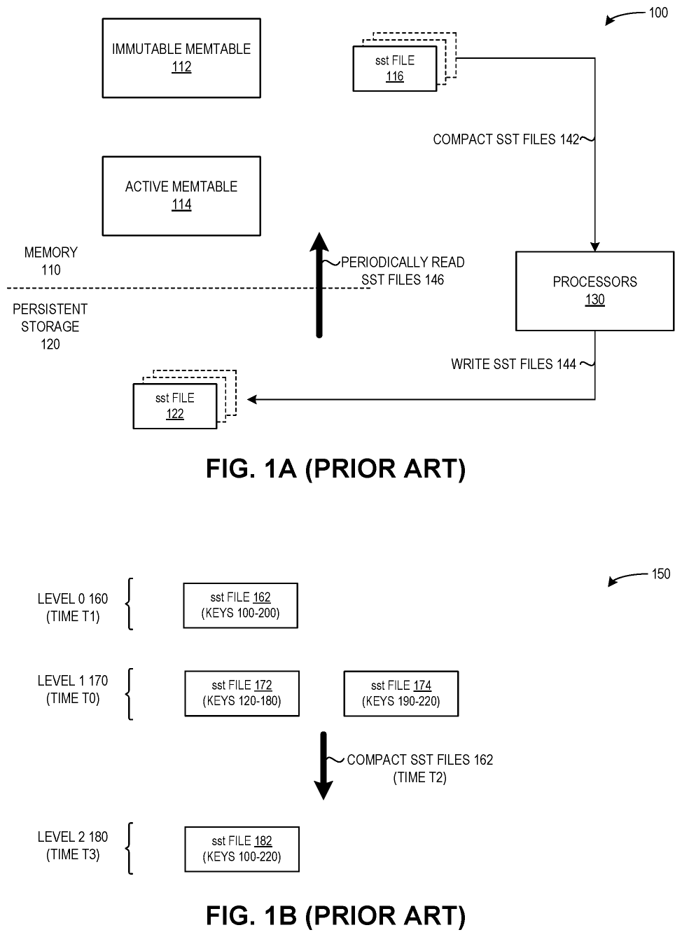

However, using the LSM tree for the key-value store can result in some inefficiencies. Data is stored in SST files in memory and written to persistent storage. The SST files are periodically read out and compacted (e.g., by merging and updating the SST files), and subsequently written back to persistent storage, which results in a write amplification. In addition, during garbage collection, the SSD reads out and merges valid pages into new blocks, which is similar to the compaction process involved with the key-value store. Thus, the existing compaction process associated with the conventional key-value store can result in both a write amplification and a performance degradation. The write amplification can result from the copying and writing performed during both the compaction process and the garbage collection process, and can further result in the wear-out of the NAND flash. The performance degradation can result from the consumption of the resources (e.g., I/O, bandwidth, and processor) by the background operations instead of providing resources to handle access by the host. These shortcomings are described below in relation to FIGS. 1A and 1B.

The write amplification and the performance degradation can decrease the efficiency of the HDD as well as the overall efficiency and performance of the storage system, and can also result in a decreased level of QoS assurance.

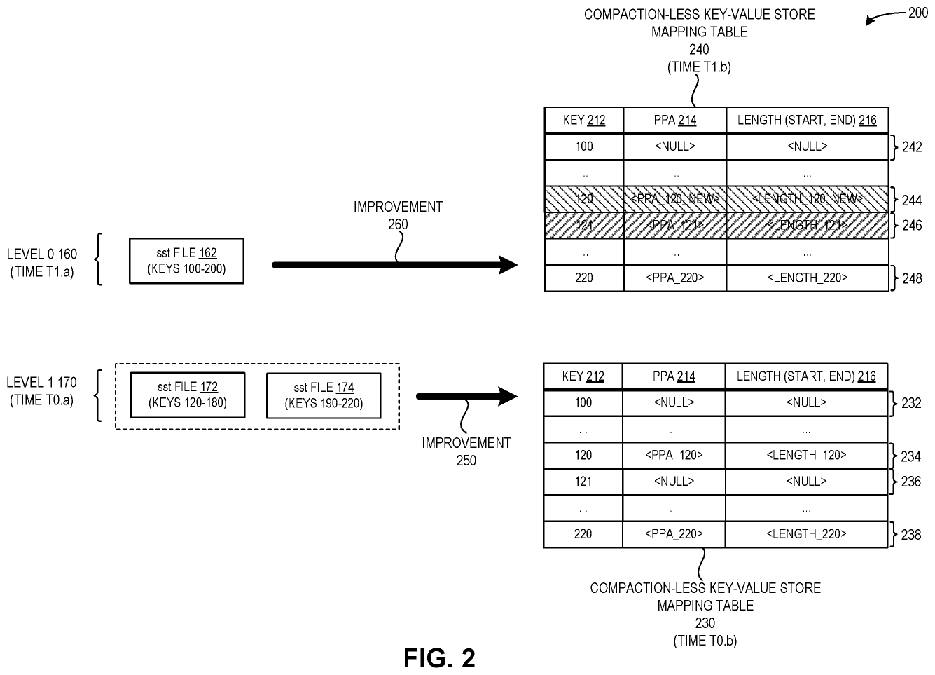

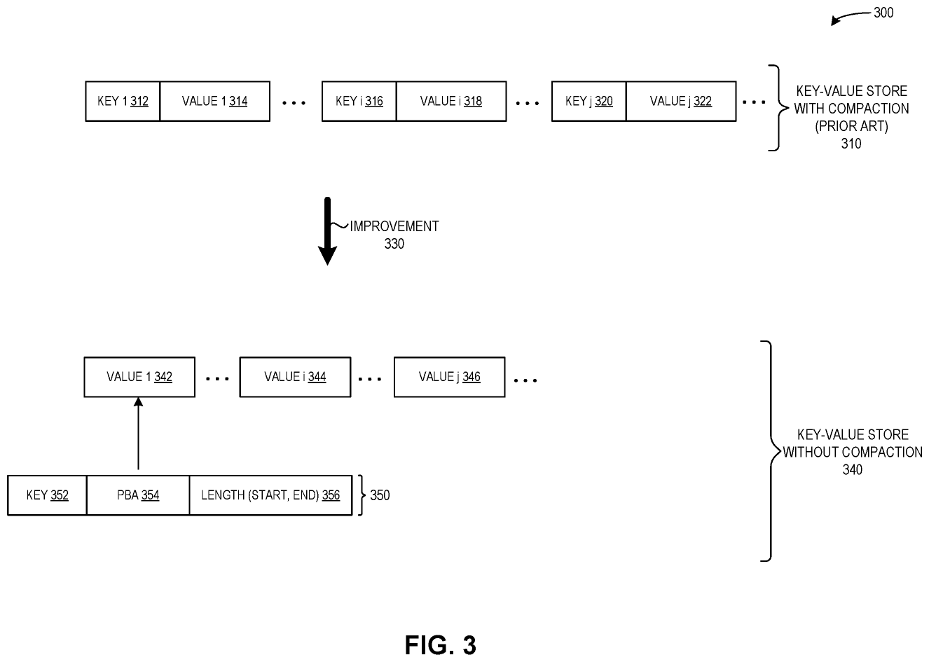

The embodiments described herein address these challenges by providing a system which uses a compaction-less key-value store and allows for a more optimal utilization of the capacity of a storage drive. The system generates a mapping table, with entries which map keys to physical addresses (e.g., a “key-to-PBA mapping table”). Each entry also includes length information, which can be indicated as a start position and an end position for a corresponding data value. Instead of reading out SST files from a storage drive and writing the merged SST files back into the storage drive, the claimed embodiments can update the key-to-PBA mapping table by “overlapping” versions of the mapping table, filling vacant entries with the most recent valid mapping, and updating any existing entries as needed. This allows the system to avoid physically moving data from one location to another (as is done when using a method involving compaction). By using this compaction-less key-value store, the system can reduce both the write amplification on the NAND flash and the resource consumption previously caused by the compaction. This can improve system's ability to handle and respond to front-end I/O requests, and can also increase the overall efficiency and performance of the storage system. The compaction-less key-value store is described below in relation to FIG. 2, while an example of the increased storage capacity using the compaction-less key-value store is described below in relation to FIG. 3.

Thus, the embodiments described herein provide a system which improves the efficiency of a storage system, where the improvements are fundamentally technological. The improved efficiency can include an improved performance in latency for completion of an I/O operation, a more optimal utilization of the storage capacity of the storage drive, and a decrease in the write amplification. The system provides a technological solution (i.e., a system which uses a key-to-PBA mapping table for a compaction-less key-value store which stores only the value in the drive and not the key-value pair, and which reduces the write amplification by eliminating compaction) to the technological problem of reducing the write amplification and performance degradation in a drive using a conventional key-value store, which improves the overall efficiency and performance of the system.

The term “physical address” can refer to a physical block address (PBA), a physical page address (PPA), or an address which identifies a physical location on a storage medium or in a storage device. The term “logical address” can refer to a logical block address (LBA).

The term “logical-to-physical mapping” or “L2P mapping” can refer to a mapping of logical addresses to physical addresses, such as an L2P mapping table maintained by a flash translation layer (FTL) module.

The term “key-to-PBA” mapping can refer to a mapping of keys to physical block addresses (or other physical addresses, such as a physical page address).

### Exemplary Flow and Mechanism for Facilitating Key-Value Storage in the Prior Art

FIG. 1A illustrates an exemplary environment 100 for facilitating a key-value store with compaction, in accordance with the prior art. Environment 100 can include a memory 110 region; a persistent storage 120 region; and processors 130. Memory 110 can include an immutable memtable 112 and an active memtable 114. Data can be written or appended to active memtable 114 until it is full, at which point it is treated as immutable memtable 112. The data in immutable memtable 112 can be flushed into an SST file 116, compacted as needed by processors 130 (see below), and written to persistent storage 120 (via a write SST files 144 function), which results in an SST file 122.

The system can periodically read out the SST files (e.g., SST file 122) from the non-volatile memory (e.g., persistent storage 120) to the volatile memory of the host (e.g., memory 110) (via a periodically read SST files 146 function). The system can perform compaction on the SST files, by merging the read-out SST files and updating the SST files based on the ranges of keys associated with the SST files (via a compact SST files 142 function), as described below in relation to FIG. 1B. The system can subsequently write the compacted (and merged and updated) SST files back to the non-volatile memory, and repeat the process. This repeated compaction can result in a high write amplification, among other challenges, as described herein.

FIG. 1B illustrates an exemplary mechanism 150 for facilitating a key-value store with compaction, in accordance with the prior art. A “level” can correspond to a time in which an SST file is created or updated, and can include one or more SST files. A level with lower number can indicate a more recent time. At a time T0, a level 1 170 can include an SST file 172 (with associated keys ranging in value from 120-180) and an SST file 174 (with associated keys ranging in value from 190-220). Subsequently, at a time T1, a level 0 160 can include an SST file 162 with keys ranging in value from 100-200. The system can compact the SST files in levels 0 and 1 (i.e., SST files 162, 172, and 174) by merging and updating the files.

For example, at a time T2, the system can perform a compact SST files 162 function (as in function 142 of FIG. 1A), by reading out SST files 172 and 174 and merging them with SST file 162. For key-value pairs in the range of keys 100-119, the system can use the values from SST file 162. For key-value pairs in the range of keys from 120-180, the system can replace the existing values from SST file 172 with the corresponding or updated values from SST file 162. For key-value pairs in the range of keys from 181-189, the system can use the values from SST file 162. For key-value pairs in the range of keys from 190-200, the system can replace the existing values from SST file 174 with the corresponding or updated values from SST file 162. For key-value pairs in the range of keys from 201-220, the system can continue to use the existing values from SST file 174.

Thus, at a time T3, a level 2 180 can include the merged and compacted SST file 182 with keys 100-220. The system can subsequently write SST file 182 to the persistent storage, as in function 144 of FIG. 1A.

However, as described above, this can result in a write amplification, as the system must periodically read out the SST files (as in function 146 of FIG. 1A). Furthermore, when the SST files are stored in the non-volatile memory of an SSD, the SSD must still perform garbage collection as a background process. During garbage collection, the SSD reads out valid pages and merges the valid pages into new blocks, which is similar to the compaction process. Thus, the existing compaction process associated with the conventional key-value store can result in both a write amplification and a performance degradation. The write amplification can result from the copying and writing performed during both the compaction process and the garbage collection process, and can further result in the wear-out of the NAND flash. The performance degradation can result from the consumption of the resources (e.g., I/O, bandwidth, and processor) by the background operations instead of providing resources to handle access by the host.

### Exemplary Environment for Facilitating a Compaction-Less Key-Value Store; Exemplary Reduced Storage Capacity

The embodiments described herein provide a system which addresses the write amplification and performance degradation challenges described above in the conventional systems. FIG. 2 illustrates an exemplary environment 200 for facilitating a compaction-less key-value store, including a table mapping keys to physical addresses, in accordance with an embodiment of the present application. In environment 200, a level 1 170 can include SST files 172 and 174 at a time T0.a, as described above in relation to FIG. 1B. In contrast, environment 200 illustrates an improvement 250 whereby in the described embodiments, instead of reading out SST files and writing the merged SST files back to the storage drive, the system can update a compaction-less key-value store mapping table 230 (at a time T0.b) (i.e., a key-to-PBA mapping table). Table 230 can include entries with a key 212, a physical address 214 (such as a PPA or a PBA), and length information 216, which can indicate a start position/location and an end position/location. For example, table 230 can include: an entry 232 with a key value of 100, a PPA value of NULL, and a length information value of NULL; an entry 234 with a key value of 120, a PPA value of “PPA_120,” and a length information value of “length_120”; an entry 236 with a key value of 121, a PPA value of NULL, and a length information value of NULL; and an entry 238 with a key value of 220, a PPA value of “PPA_220,” and a length information value of “length_220.”

Subsequently, the system can determine an update to mapping table 230. In the conventional method of FIGS. 1A and 1B, a level 0 160 can include an SST file 162 at a time T1.a, which is compacted by merging and updating with SST files 172 and 174 in level 1 170, as described above in relation to FIG. 1B. In contrast, environment 200 illustrates an improvement 260 whereby in the described embodiments, instead of reading out SST files and writing the merged SST files back to the storage drive, the system can update a compaction-less key-value store mapping table 240 (at a time T1.b) (i.e., a key-to-PBA mapping table which corresponds to mapping table 230, but at a subsequent time T1.b). That is, the system can “overlap” tables 230 and 240, by updating table 230, which results in table 240. As part of improvement 260, the system can replace a vacant entry and can update an existing entry.

For example, in mapping table 240, the system can replace the prior (vacant) entry for key value 121 (entry 236 of table 230) with the (new) information for key value 100 (entry 246 of table 240, with a PPA value of “PPA_121” and a length information value of “length_121,” which entry is indicated with shaded right-slanting diagonal lines). Also, in mapping table 240, the system can update the prior (existing) entry for key value 120 (entry 234 of table 230) with the new information for key value 120 (entry 244 of table 240, with a PPA value of “PPA_120_new” and a length information value of “length_120_new,” which entry is indicated with shaded left-slanting diagonal lines).

Thus, environment 200 depicts how the claimed embodiments use a compaction-less key-value store mapping table to avoid the inefficient compaction required in the conventional systems, by overlapping versions of the key-to-PBA mapping table, filling vacant entries with the latest valid mapping, and updating existing entries, which results in an improved and more efficient system.

Furthermore, the claimed embodiments can result in an improved utilization of the storage capacity of a storage drive. FIG. 3 illustrates an exemplary environment 300 illustrating an improved utilization of storage capacity by comparing a key-value store with compaction 310 (in accordance with the prior art) with a key-value store without compaction 340 (in accordance with an embodiment of the present application). In scheme 310, key-value pairs are stored in the storage drive, where a pair includes, e.g., a key 1 312 and a corresponding value 1 314. Similarly, a pair can include: a key i 316 and a corresponding value i 318; and a key j 320 and a corresponding value j 322.

The embodiments of the claimed invention provide an improvement 330 by storing mappings between keys and physical addresses in a key-to-PBA mapping table, and by storing only the value corresponding to the PBA in the storage drive. For example, an entry 350 can include a key 352, a PBA 354, and length information 356 (indicating a start position and an end position). Because key 352 is already stored in the mapping table, the system need only store a value 1 342 corresponding to PBA 354 in the storage drive. This can result in a significant space savings and an improved utilization of the storage capacity. For example, assuming that the average size of a key is 20 bytes and that the average size of the value is 200 bytes, the system can save approximately 10% in the utilization of the capacity of the storage drive, thereby providing a significant space savings.

Thus, environments 200 and 300 illustrate how the system can use a key-to-PBA mapping table for a compaction-less key-value store which stores only the value in the drive and not the key-value pair, and which reduces the write amplification by eliminating compaction. This can improve the overall efficiency and performance of the system.

### Exemplary Environment for Facilitating Data Placement: Communication Between Host Memory and Sub-Tables

The host memory (e.g., host DRAM) can maintain the key-to-PBA mapping when running a host-based flash translation layer (FTL) module. The system can divide the entire mapping table into a plurality of sub-tables based on the key ranges and the mapped relationships between the keys and the physical addresses. The system can store each sub-table on a different storage drive or storage device based on the key ranges and the corresponding physical addresses.

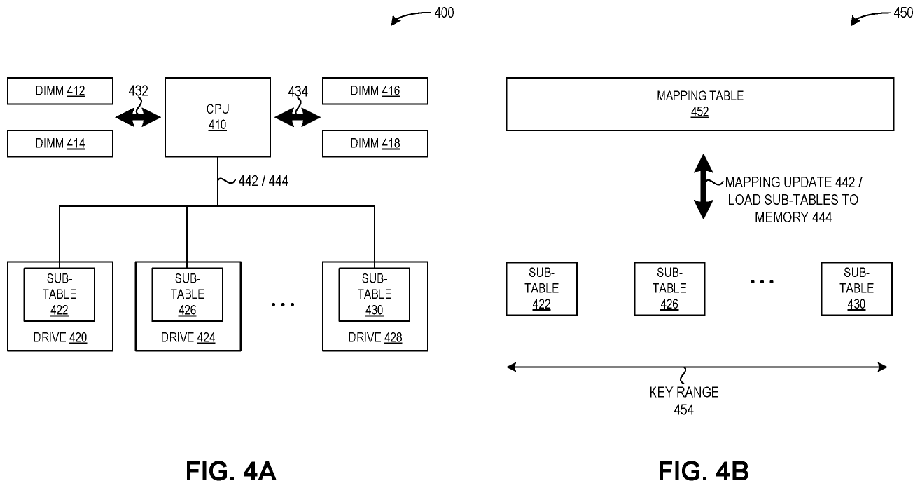

FIG. 4A illustrates an exemplary environment 400 (such as a storage server) for facilitating data placement in a storage device, including communication between host memory and a plurality of sub-tables in a plurality of storage devices, in accordance with an embodiment of the present application. Environment 400 can include a central processing unit (CPU) 410 which can communicate via, e.g., communications 432 and 434 with associated dual in-line memory modules (DIMMs) 412, 414, 416, and 418. Environment 400 can also include multiple storage devices, such as drives 420, 424, and 428. The key-to-PBA mapping table of the embodiments described herein can be divided into a plurality of sub-tables, and stored across the multiple storage devices (or drives). For example: a sub-table 422 can be stored in drive 420; a sub-table 426 can be stored in drive 424; and a sub-table 430 can be stored in drive 428.

FIG. 4B illustrates an exemplary environment 450 for facilitating data placement in a storage device, corresponding to the environment of FIG. 4A, in accordance with an embodiment of the present application. Environment 450 can include a mapping table 452, which is the key-to-PBA mapping table discussed herein. Sub-tables 422, 426, and 430 are depicted as covering and corresponding to a key range 454. That is, each sub-table can correspond to a specific key range and corresponding physical addresses.

During operation, the system can update mapping table 452 (via a mapping update 442 communication) by modifying an entry in mapping table 452, which entry may only be a few bytes. When the system powers up (e.g., upon powering up the server), the system can load the sub-tables 422, 426, and 430 from, respectively, drives 420, 424, and 428 to the host memory (e.g., DIMMs 412-418) to generate mapping table 452 (via a load sub-tables to memory 444 communication).

### Mapping Between Keys and Physical Locations Using a Device-Based FTL

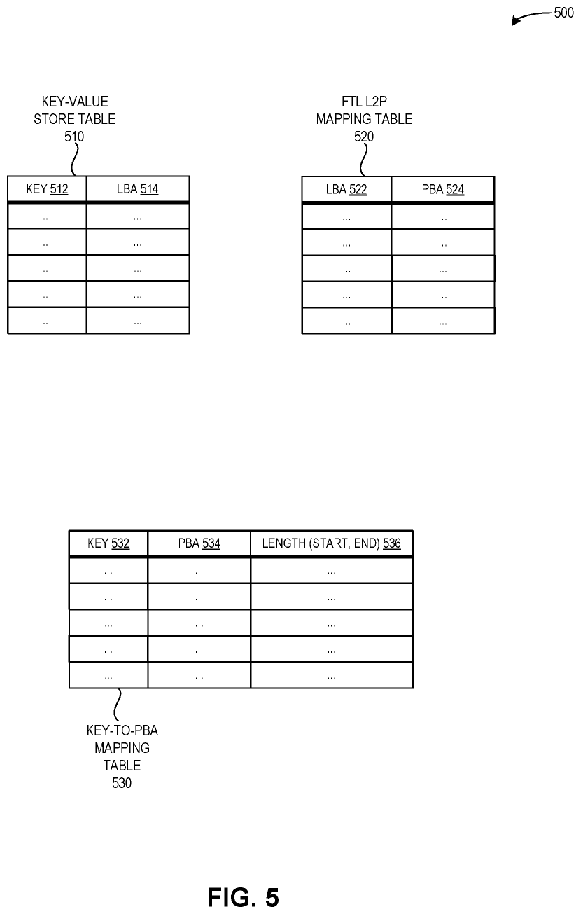

FIG. 5 illustrates a mapping between keys and physical locations by a flash translation layer module (FTL) associated with a storage device, including two steps, in accordance with an embodiment of the present application. A device-based FTL can accomplish the mapping of keys to physical addresses by using two tables: 1) a key-value store table 510; and 2) an FTL L2P mapping table 520. Table 510 includes entries which map keys to logical addresses (such as LBAs), and table 520 includes entries which map logical addresses (such as LBAs) to physical addresses (such as PBAs). For example, table 510 can include entries with a key 512 which is mapped to an LBA 514, and table 520 can include entries with an LBA 522 which is mapped to a PBA 524.

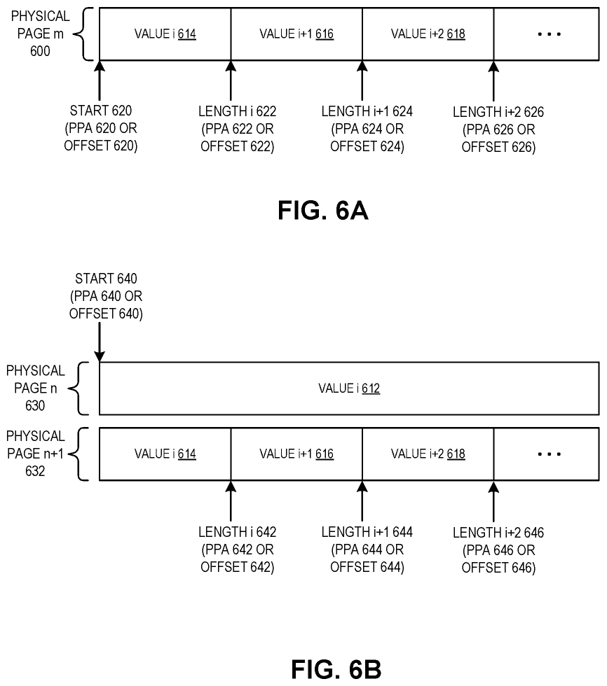

By using tables 510 and 520, the device-based FTL can generate a key-to-PBA mapping table 530, which can include entries with a key 532, a PBA 534, and length information 536. Length information 536 can indicate a start location and an end location of the value stored at the PBA mapped to a given key. The start location can indicate the PPA of the start location, and the end location can indicate the PPA of the end location. A large or long value may be stored across several physical pages, and the system can retrieve such a value based on the length information, e.g., by starting at the mapped PBA and going to the indicated start location (e.g., PPA or offset) and reading until the indicated end location (e.g., PPA or offset), as described below in relation to FIGS. 6A and 6B.

### Exemplary Placement of Data Values

FIG. 6A illustrates an exemplary placement of a data value in a physical page, in accordance with an embodiment of the present application. Data (e.g., data values) can be placed in a physical page m 600 of a given block (e.g., based on the PBA in the key-to-PBA mapping table), where the start location and the end location are indicated in the length or length information. For example, a value i 614 can begin at a start 620 (which can be indicated by a PPA 620 or an offset 620), and be of a length i 622 (which can be indicated by a PPA 622 or an offset 622). Similarly, a value i+1 616 can begin at a start (which can be indicated by a PPA 622 or an offset 622), and be of a length i+1 624 (which can be indicated by a PPA 624 or an offset 624). Also, a value i+2 618 can begin at a start (which can be indicated by a PPA 624 or an offset 624), and be of a length i+2 626 (which can be indicated by a PPA 626 or an offset 626).

FIG. 6B illustrates an exemplary placement of a data value across multiple physical pages, in accordance with an embodiment of the present application. Data values can be placed across multiple physical pages of a given block (as in FIG. 6A), including a physical page n 630 and a physical page n+1 632. For example, a first portion of value i 612 can be placed in physical page n 630, while a remainder or second portion of value i 614 can be placed in physical page n+1 632. A start 640 (or a PPA 640 or an offset 640) can denote the starting location of value i 612 in physical page n 630, and a length i 642 (or PPA 642 or offset 642) can indicate an end location for value i (i.e., for the remaining portion of value i 614 in physical page n+1 632). Thus, FIG. 6B illustrates how data stored across multiple pages can be placed and subsequently retrieved based on a corresponding PBA and the length information stored in the key-to-PBA mapping table, where the length information can indicate a starting location and an ending location (e.g., as a PPA or an offset).

### Method for Facilitating Data Placement in a Storage Device

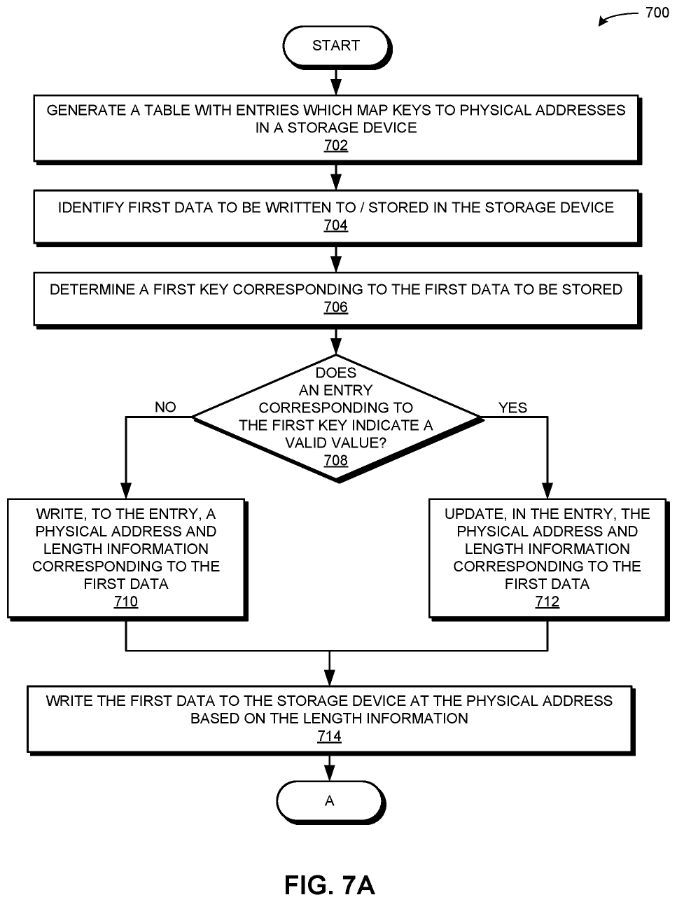

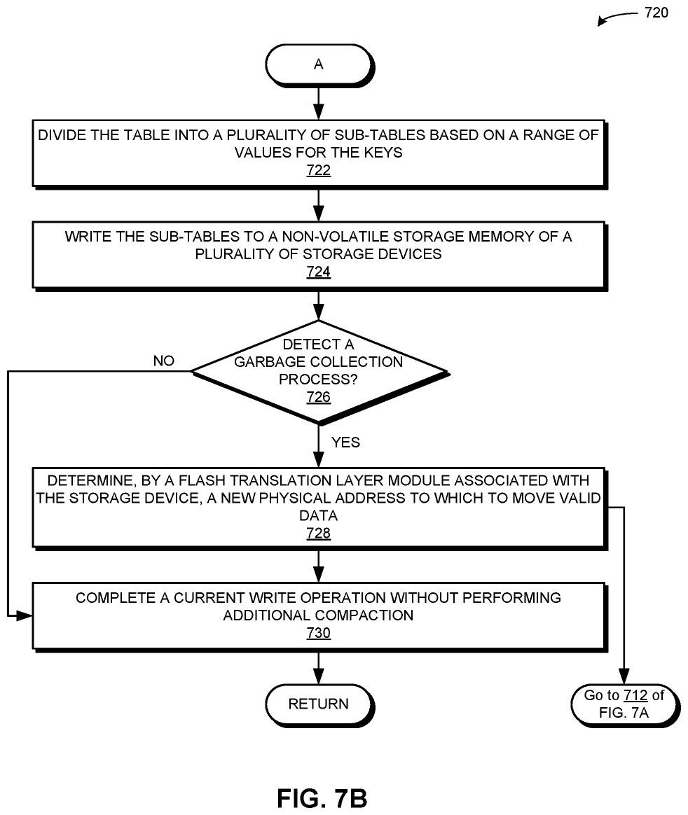

FIG. 7A presents a flowchart 700 illustrating a method for facilitating data placement in a storage device, in accordance with an embodiment of the present application. During operation, the system generates a table with entries which map keys to physical addresses in a storage device (operation 702). The system identifies first data to be written to/stored in the storage device (operation 704). The system determines a first key corresponding to the first data to be stored (operation 706). If an entry corresponding to the first key does not indicate a valid value (decision 708), the system writes, to the entry, a physical address and length information corresponding to the first data (operation 710). If an entry corresponding to the first key does indicate a valid value (decision 708), the system updates, in the entry, a physical address and length information corresponding to the first data (operation 712). The system writes the first data to the storage device at the physical address based on the length information (operation 714), and the operation continues at Label A of FIG. 7B.

FIG. 7B presents a flowchart 720 illustrating a method for facilitating data placement in a storage device, in accordance with an embodiment of the present application. The system divides the table into a plurality of sub-tables based on a range of values for the keys (operation 722). The system writes the sub-tables to a non-volatile storage memory of a plurality of storage devices (operation 724). If the system does not detect a garbage collection process (decision 726), the operation continues at operation 730.

If the system detects a garbage collection process (decision 726), the system determines, by a flash translation layer module associated with the storage device, a new physical address to which to move valid data (operation 728). The operation can continue at operation 712 of FIG. 7A. The system can also complete a current write operation without performing additional compaction (operation 730), and the operation returns.

### Exemplary Computer System and Apparatus

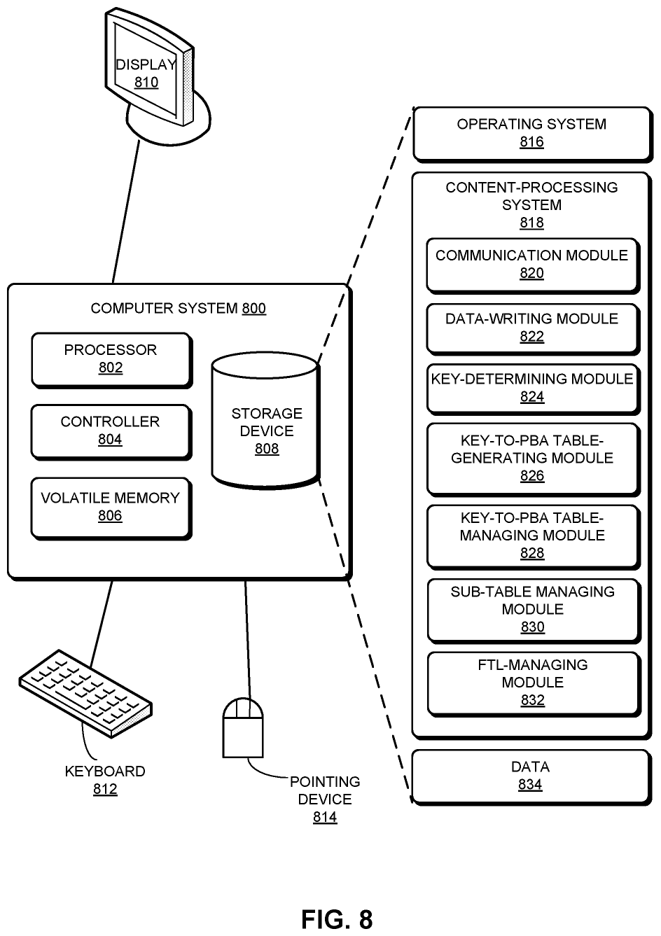

FIG. 8 illustrates an exemplary computer system that facilitates data placement in a storage device, in accordance with an embodiment of the present application. Computer system 800 includes a processor 802, a controller 804, a volatile memory 806, and a storage device 808. Volatile memory 806 can include, e.g., random access memory (RAM), that serves as a managed memory, and can be used to store one or more memory pools. Storage device 808 can include persistent storage which can be managed or accessed via controller 804. Furthermore, computer system 800 can be coupled to a display device 810, a keyboard 812, and a pointing device 814. Storage device 808 can store an operating system 816, a content-processing system 818, and data 834.

Content-processing system 818 can include instructions, which when executed by computer system 800, can cause computer system 800 to perform methods and/or processes described in this disclosure. Specifically, content-processing system 818 can include instructions for receiving and transmitting data packets, including data to be read or stored, a key value, a data value, a physical address, a logical address, an offset, and length information (communication module 820).

Content-processing system 818 can also include instructions for generating a table with entries which map keys to physical addresses (key-to-PBA table-generating module 826). Content-processing system 818 can include instructions for determining a first key corresponding to first data to be stored (key-determining module 824). Content-processing system 818 can include instructions for, in response to determining that an entry corresponding to the first key does not indicate a valid value, writing, to the entry, a physical address and length information corresponding to the first data (key-to-PBA table-managing module 828). Content-processing system 818 can include instructions for, in response to determining that the entry corresponding to the first key does indicate a valid value, updating, in the entry, the physical address and length information corresponding to the first data (key-to-PBA table-managing module 828). Content-processing system 818 can include instructions for writing the first data to the storage device at the physical address based on the length information (data-writing module 822).

Content-processing system 818 can further include instructions for dividing the table into a plurality of sub-tables based on a range of values for the keys (sub-table managing module 830). Content-processing system 818 can include instructions for writing the sub-tables to a non-volatile memory of a plurality of storage devices (data-writing module 822).

Content-processing system 818 can include instructions for, in response to detecting a garbage collection process, determining, by a flash translation layer module associated with the storage device, a new physical address to which to move valid data (FTL-managing module 832). Content-processing system 818 can include instructions for updating, in a second entry corresponding to the valid data, the physical address and length information corresponding to the valid data (FTL-managing module 832).

Data 834 can include any data that is required as input or that is generated as output by the methods and/or processes described in this disclosure. Specifically, data 834 can store at least: data; valid data; invalid data; out-of-date data; a table; a data structure; an entry; a key; a value; a logical address; a logical block address (LBA); a physical address; a physical block address (PBA); a physical page address (PPA); a valid value; a null value; an invalid value; an indicator of garbage collection; data marked to be recycled; a sub-table; length information; a start location or position; an end location or position; an offset; data associated with a host-based FTL or a device-based FTL; a size; a length; a mapping of keys to physical addresses; and a mapping of logical addresses to physical addresses.

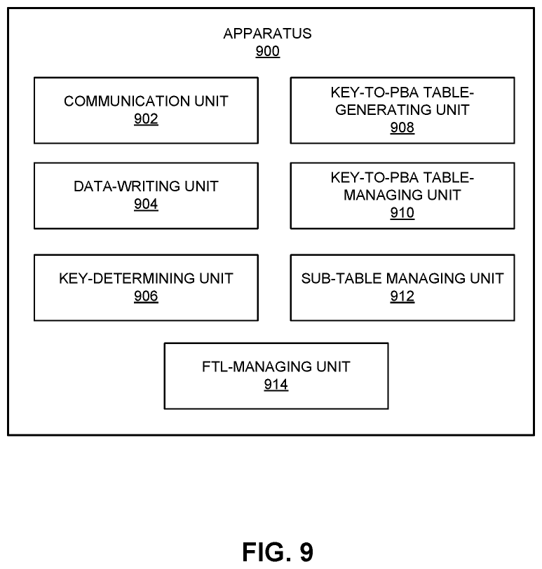

FIG. 9 illustrates an exemplary apparatus that facilitates data placement in a storage device, in accordance with an embodiment of the present application. Apparatus 900 can comprise a plurality of units or apparatuses which may communicate with one another via a wired, wireless, quantum light, or electrical communication channel. Apparatus 900 may be realized using one or more integrated circuits, and may include fewer or more units or apparatuses than those shown in FIG. 9. Further, apparatus 900 may be integrated in a computer system, or realized as a separate device which is capable of communicating with other computer systems and/or devices. Specifically, apparatus 900 can comprise units 902-914 which perform functions or operations similar to modules 820-832 of computer system 800 of FIG. 8, including: a communication unit 902; a data-writing unit 904; a key-determining unit 906; a key-to-PBA table-generating unit 908; a key-to-PBA table-managing unit 910; a sub-table managing unit 912; and an FTL-managing unit 914.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing embodiments described herein have been presented for purposes of illustration and description only. They are not intended to be exhaustive or to limit the embodiments described herein to the forms disclosed. Accordingly, many modifications and variations will be apparent to practitioners skilled in the art. Additionally, the above disclosure is not intended to limit the embodiments described herein. The scope of the embodiments described herein is defined by the appended claims.

What is claimed is:

1. A computer-implemented method for facilitating data placement in a storage device, the method comprising:
generating a table with entries which map keys to physical addresses;
determining a first key corresponding to first data to be stored;
in response to determining that an entry corresponding to the first key does not indicate a valid value, writing, to the entry, a physical address and length information corresponding to the first data;
in response to determining that the entry corresponding to the first key does indicate a valid value, updating, in the entry, the physical address and length information corresponding to the first data; and
writing the first data to the storage device at the physical address based on the length information.

2. The method of claim 1, further comprising:
dividing the table into a plurality of sub-tables based on a range of values for the keys; and
writing the sub-tables to a non-volatile memory of a plurality of storage devices.

3. The method of claim 1, further comprising:
in response to detecting a garbage collection process, determining, by a flash translation layer module associated with the storage device, a new physical address to which to move valid data;
updating, in a second entry corresponding to the valid data, the physical address and length information corresponding to the valid data.

4. The method of claim 3, wherein prior to generating the table, the method further comprises:
generating a first data structure with entries mapping the keys to logical addresses; and
generating, by the flash translation layer associated with the storage device, a second data structure with entries mapping the logical addresses to the corresponding physical addresses.

5. The method of claim 1, wherein the length information corresponding to the first data indicates a starting position and an ending position for the first data.

6. The method of claim 5, wherein the starting position and the ending position indicate one or more of:
a physical page address;
an offset; and
a length or size of the first data.

7. The method of claim 1, wherein the physical address is one or more of:
a physical block address; and
a physical page address.

8. A computer system for facilitating data placement, the system comprising:
a processor; and
a memory coupled to the processor and storing instructions, which when executed by the processor cause the processor to perform a method, wherein the computer system comprises a storage device, the method comprising:
generating a table with entries which map keys to physical addresses;
determining a first key corresponding to first data to be stored;
in response to determining that an entry corresponding to the first key does not indicate a valid value, writing, to the entry, a physical address and length information corresponding to the first data;
in response to determining that the entry corresponding to the first key does indicate a valid value, updating, in the entry, the physical address and length information corresponding to the first data; and
writing the first data to the storage device at the physical address based on the length information.

9. The computer system of claim 8, wherein the method further comprises:
dividing the table into a plurality of sub-tables based on a range of values for the keys; and
writing the sub-tables to a non-volatile memory of a plurality of storage devices.

10. The computer system of claim 8, wherein the method further comprises:
in response to detecting a garbage collection process, determining, by a flash translation layer module associated with the storage device, a new physical address to which to move valid data;
updating, in a second entry corresponding to the valid data, the physical address and length information corresponding to the valid data.

11. The computer system of claim 10, wherein prior to generating the table, the method further comprises:
generating a first data structure with entries mapping the keys to logical addresses; and
generating, by the flash translation layer associated with the storage device, a second data structure with entries mapping the logical addresses to the corresponding physical addresses.

12. The computer system of claim 8, wherein the length information corresponding to the first data indicates a starting position and an ending position for the first data.

13. The computer system of claim 12, wherein the starting position and the ending position indicate one or more of:
a physical page address;
an offset; and
a length or size of the first data.

14. The computer system of claim 1, wherein the physical address is one or more of:
a physical block address; and
a physical page address.

15. A non-transitory computer-readable storage medium storing instructions that when executed by a computer cause the computer to perform a method, the method comprising:
generating a table with entries which map keys to physical addresses;
determining a first key corresponding to first data to be stored;
in response to determining that an entry corresponding to the first key does not indicate a valid value, writing, to the entry, a physical address and length information corresponding to the first data;
in response to determining that the entry corresponding to the first key does indicate a valid value, updating, in the entry, the physical address and length information corresponding to the first data; and
writing the first data to the storage device at the physical address based on the length information.

16. The storage medium of claim 15, wherein the method further comprises:
dividing the table into a plurality of sub-tables based on a range of values for the keys; and
writing the sub-tables to a non-volatile memory of a plurality of storage devices.

17. The storage medium of claim 15, wherein the method further comprises:
in response to detecting a garbage collection process, determining, by a flash translation layer module associated with the storage device, a new physical address to which to move valid data;
updating, in a second entry corresponding to the valid data, the physical address and length information corresponding to the valid data.

18. The storage medium of claim 17, wherein prior to generating the table, the method further comprises:
generating a first data structure with entries mapping the keys to logical addresses; and
generating, by the flash translation layer associated with the storage device, a second data structure with entries mapping the logical addresses to the corresponding physical addresses.

19. The storage medium of claim 15, wherein the length information corresponding to the first data indicates a starting position and an ending position for the first data.

20. The storage medium of claim 19, wherein the starting position and the ending position indicate one or more of:
a physical page address;
an offset; and
a length or size of the first data.
